(19) United States
(12) Patent Application Publication
(10) Pub. No.: US 2009/0114631 A1
(43) Pub. Date: May 7, 2009

(54) Short-Circuit ARC Welding Process Using A Consumable Electrode

(75) Inventors: Richard Chevalier, Pontoise (FR); Sebastien Gadrey, Gouloux (FR); Gerard Plottier, Pierrefitte (FR); Olivier Revel, Pierrelaye (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude et l'Exploitation Des Procedes Georges Claude, Paris (FR)

(21) Appl. No.: 12/261,702

(22) Filed: Oct. 30, 2008

(30) Foreign Application Priority Data
Nov. 6, 2007 (FR) FR 0758825

(51) Int. Cl. B23K 9/095; B23K 9/173

(52) U.S. Cl. 219/137.7; 219/137 R; 219/137.2; 219/137.71

(57) ABSTRACT

An arc welding process using a consumable electrode, in which welding cycles follow one after another over the course of time, each comprising an arc period and a short-circuit period in which the liquid metal establishes a short-circuit between the end of the electrode and the workpiece or workpieces. Each cycle comprises the steps of: maintaining an arc current I₂ at the same time as the consumable electrode is moved towards the workpiece; reducing the current so as to reach a minimum current I₁ at the start of the short-circuit; reducing the speed of the consumable wire electrode; increasing the current over the short-circuit period in order to reach a maximum value I₄; and then reducing the current over the short-circuit period in order to reach a minimum value I₁.

This application claims priority to French Patent Application FR 0758825 filed Nov. 6, 2007.

### FIELD OF INVENTION

The present invention relates to the field of arc welding employing a consumable electrode, through which a current flows, and a gas shield for shielding the weld pool.

### BACKGROUND

MIG or MAG welding, standing for metal inert gas and metal active gas respectively, are techniques for arc welding or arc braze welding with a consumable electrode and a shielding gas, especially for a metal sheet or plate, whether coated or not. These welding techniques are also known by the term GMAW (Gas Metal Arc Welding).

When these MIG or MAG processes are being carried out, the heat generated by the electric arc melts the end of the filler metal, the consumable wire, and melts the base metal, i.e. the constituent metal or metal alloy of the pieces to be welded. A gas or a gas mixture is usually provided for shielding the weld pool, i.e. the welded joint being formed, from atmospheric contaminations during welding.

A known device for MIG or MAG arc welding comprises, schematically, power supply means, a control circuit and a metal wire or consumable electrode positioned close to, especially above, one or more workpieces to be welded on which a weld is to be produced.

Measurement means are used to determine the current (I) flowing in the workpiece(s) to be welded and the voltage (U) between a workpiece to be welded and the electrode. These measurement means are also used to control the current supply means and/or the control circuit.

The consumable electrode is a meltable wire through which an electric current delivered by the supply means flows. The current flow is controlled by the control circuit and heats up the end of the wire located facing the workpieces or the weld pool. The end of the wire melts, thereby causing a droplet to form, which is then deposited on the workpiece(s) in the joint plane.

More precisely, metal transfer from the electrode to the weld pool takes place according to a known standard operating mode, called short-circuit transfer. This short-circuit transfer mode is obtained for low arc energies, typically for a current less than 200 A and a voltage of around 14 to 20 V, and is characterized by the formation of a droplet of molten metal on the end of the wire coming into contact with the liquid metal pool. Upon contact, the current I rapidly increases, causing the appearance of pinching or necking, making it easier for the droplet of molten metal to be detached and to drop into the weld pool. This phenomenon is repeated over the course of time and therefore as the welded joint continues to be formed, at frequencies of around 50 to 200 Hz.

This short-circuit welding technique is used for welding small thicknesses, typically less than 5 mm, thanks to the weld pool being well controlled, but it does lead to a short and unstable arc and to metal spatter on the welded workpieces, impairing their quality.

Furthermore, it may happen that the incident energy is too high, thus causing excess penetration or even piercing of the metal sheet. It should also be noted that the rate of deposition is relatively low when it is desired to reduce the welding energy and that it is very difficult to establish a stable arc regime with low currents.

In certain cases, as in pulsed transfer in which the arc is stable, the high energies involved lead to substantial deformation of the final workpiece. This results from the intrinsic operation of pulsed transfer, which is obtained thanks to very high current peaks around 450 A leading to detachment of the droplets from the consumable wire before they come into contact with the workpiece, but this then causes deformation since the energy needed to detach the droplets is too high for the workpiece.

Various methods have been proposed to try to control the current better and in particular to limit the spattering that occurs when the neck breaks.

Thus, a first welding process called CSC or CSC-MIG welding (CSC standing for controlled short-circuiting) was proposed.

This CSC process, illustrated in particular in document EP-A-1 384 546, employs a reciprocating movement, i.e. a mechanical forward-and-back movement, in the pay-out of the wire constituting the consumable electrode so as to reduce the energy to strike the arc and therefore the amount of metal spatter. However, this process is not ideal as it is limited by a low transfer frequency and a short-circuit transfer mode has to be maintained. Furthermore, since the transfer frequency is relatively low, that is to say the transfer periods are relatively long, the droplets that form are large. This causes difficulties when welding thin sheets. Thus, in practice it is not conceivable to obtain good-quality welds on sheets with a thickness of less than 0.8 mm using the CSC process. It should also be noted that a device suitable for implementing a CSC process is relatively complicated and expensive, especially because means for applying a “negative” speed to the consumable wire electrode have to be provided.

Moreover, another welding process, called the STT (surface tension transfer) welding process, has been proposed.

This STT process, especially illustrated by document FR-A-2 666 261, employs a current pulse generated before the arc is reignited, and therefore during the short-circuit period, so as to initiate the necking of the liquid metal bridge, while preventing the arc from being restruck under the high current.

Although advantageous, as it allows the energy for detaching a metal droplet to be controlled quite precisely, this process, if not controlled properly, frequently results in undesirable spatter. Furthermore, it is complicated to implement and requires many parameters to be precisely regulated. This limits its range of regulation and use.

The object of the present invention is to remedy the aforementioned drawbacks of the GMAW, CSC and STT processes while still maintaining the capability of controlling the short-circuit transfer.

In other words, the problem that arises is to provide an arc welding process employing a consumable electrode through which an electric current flows that makes it possible to obtain short transfer periods and to prevent metal spatter so as to improve the quality of the weld.

### SUMMARY OF THE INVENTION

The present invention is therefore an arc welding process employing a consumable electrode, one end of which is progressively melted by an electric current supplied to the electrode, in which welding cycles (A-C-A) follow one after another over the course of time (t), each comprising an arc period (Uₐ; instants A-C) and a short-circuit period (C-A) in which the liquid metal establishes a short-circuit (SC) between the molten end of the electrode and at least one workpiece to be welded, each cycle comprising the steps of:

a) maintaining an arc current I₂ for a period (A₃ to A₄) of the arc period (A-C) at the same time as the consumable electrode is moved at a speed V₁, preferably an approximately constant speed V₁, towards the workpiece to be welded;

b) reducing the current so as to reach a minimum current I₁ at the start(at C) of the short-circuit period, where I₁<I₂;

c) reducing the speed of the consumable wire electrode in order to reach a minimum speed V₃, where V₃<V₁, during at least part of the short-circuit period (C-A);

d) increasing the current over the short-circuit period (C-A) in order to reach a maximum value I₄, where I₄≧I₂; and

e) then, after step d), reducing the current over the short-circuit period (C-A) in order to reach a minimum value I₁, where I₁<I₂.

### BRIEF DESCRIPTION OF THE FIGURES

The invention will be described below in greater detail with reference to the appended illustrative figures:

FIG. 1a shows the current cycle, the voltage cycle and the wire speed cycle over the course of time (t, plotted on the x-axis) that are obtained while a CSC welding process according to the prior art is being carried out.

FIG. 1b shows the current cycle, the voltage cycle and the wire speed cycle over the course of time (t, plotted on the x-axis) that are obtained while a CSC welding process according to the prior art is being carried out.

FIG. 1c shows the current cycle, the voltage cycle and the wire speed cycle over the course of time (t, plotted on the x-axis) that are obtained while a CSC welding process according to the prior art is being carried out.

FIG. 2a shows the current cycle, the voltage cycle and the wire speed cycle over the course of time (t, plotted on the x-axis) that are obtained while an STT welding process according to the prior art is being carried out.

FIG. 2b shows the current cycle, the voltage cycle and the wire speed cycle over the course of time (t, plotted on the x-axis) that are obtained while an STT welding process according to the prior art is being carried out.

FIG. 2c shows the current cycle, the voltage cycle and the wire speed cycle over the course of time (t, plotted on the x-axis) that are obtained while an STT welding process according to the prior art is being carried out.

FIG. 3a shows the current cycle, the voltage cycle and the wire speed cycle over the course of time (t, plotted on the x-axis) that are obtained while a welding process according to the present invention is being carried out.

FIG. 3b shows the current cycle, the voltage cycle and the wire speed cycle over the course of time (t, plotted on the x-axis) that are obtained while a welding process according to the present invention is being carried out.

FIG. 3c shows the current cycle, the voltage cycle and the wire speed cycle over the course of time (t, plotted on the x-axis) that are obtained while a welding process according to the present invention is being carried out.

### DETAILED DESCRIPTION OF THE INVENTION

Thanks to the increase in current and at the same time the reduction in speed of the consumable wire electrode during the short-circuit period, brief short-circuit periods can be obtained, especially of shorter duration than those obtained with a CSC process as the wire is not mechanically withdrawn from the weld pool. Thus, it is possible for the droplet of molten metal to be transferred rapidly and very controllably, preventing spatter from being generated. In other words, during steps d) and e), a current peak is produced during part of the short-circuit period, enabling the metal droplets to be detached during the short-circuits, through the effect of the wire deceleration combined, at the same time, with the effect of the current pulse.

More precisely, during the short-circuit, the voltage naturally drops, since the potential difference is zero. At this moment, the current is made to rise over a defined time through the electronic acquisition/regulation control system of the welding generator and, in the same way, the welding generator stops the wire feed motor from paying out the wire. The droplet is therefore transferred, i.e. detached, by a capillary effect helped by the rise in current and the stopping of the wire. The arc is then re-established at low current controlled by the welding generator which, after a given time, generates the current for forming a liquid metal droplet for the next short-circuit. During this same period, the generator controls the wire feed motor so that the wire is paid out until the next short-circuit.

According to various embodiments, the invention may comprise one or more of the following features:

the minimum speed V₃ is approximately zero, that is to say zero (V₃=0) or almost zero (V₃ very close to 0);

the minimum speed V₃ is maintained at the start of the arc period (at A);

at step d), the increase in the current (from I₁ to I₄) over the short-circuit period takes place while the speed of the consumable wire electrode is being reduced (from V₁ to V₃) in step c);

the increase in the current (from I₁ to I₄) over the short-circuit period and the reduction in the speed of the wire electrode down to the minimum speed V₃ (preferably V₃=0) causes at least one droplet of molten metal to be detached from the molten end of the electrode;

the maximum current I₄ is maintained during a hold period (C₂ to C₃) while the speed of the consumable wire electrode is maintained at the minimum speed V₃;

the voltage is measured so as to trigger the drop in current before the arc is re-established, while the speed of the consumable wire electrode is maintained at the minimum speed V₃; and

during welding, a gas shield is employed and one or more metal workpieces, made of a metal or a metal alloy chosen from coated or uncoated carbon steels, coated or uncoated stainless steels and coated or uncoated aluminium or titanium, are welded.

The subject of the invention is also a device for controlling the power supply to a short-circuit metal-transfer arc-welding generator employing a consumable electrode, said generator comprising means for supplying electric current and a control circuit that are capable of implementing the above process.

The subject of the invention is also a computer program product for a data processing means, the computer program product comprising a series of instructions which, when they are input into the data processing means, enable the data processing means to carry out one or more of the steps of the above process.

The subject of the invention is further a computer-readable medium, comprising one or more sequences of instructions for the above computer program product.

The invention also relates to a MIG/MAG welding current generator comprising means for supplying electric current and a device for controlling said power supply means according to the above device and/or employing the above computer program product and/or the above medium comprising the sequences of instructions.

The invention will be described below in greater detail with reference to the appended illustrative figures that show, respectively, the current cycle, the voltage cycle and the wire speed cycle over the course of time (t, plotted on the x-axis) that are obtained:

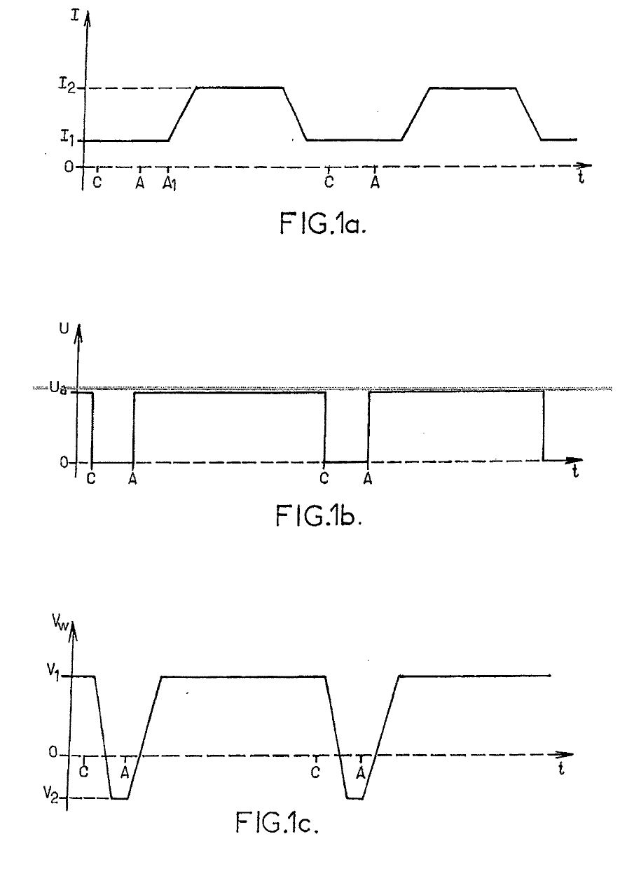

in the case of FIGS. 1a to 1c, while a CSC welding process according to the prior art is being carried out;

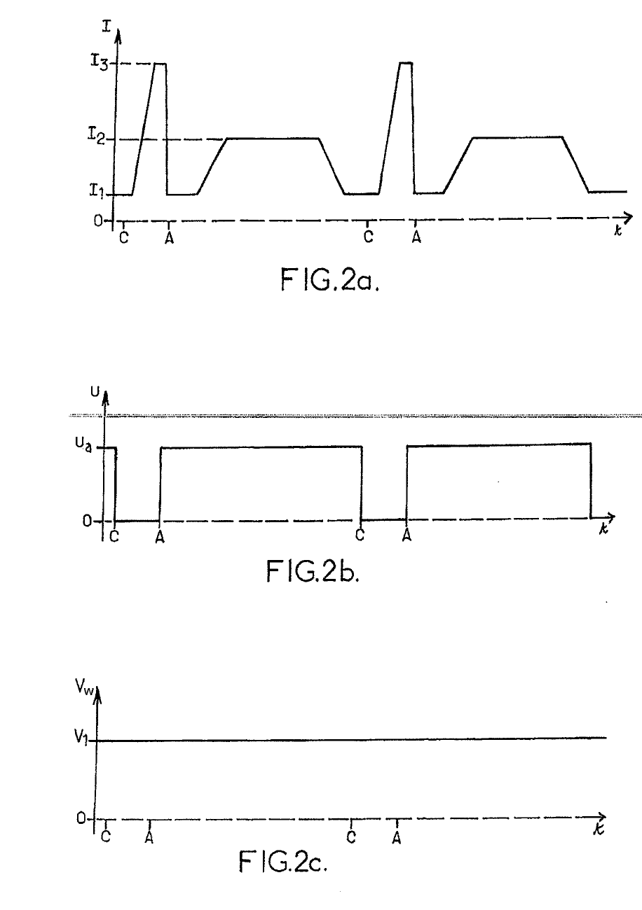

in the case of FIGS. 2a to 2c, while an STT welding process according to the prior art is being carried out; and

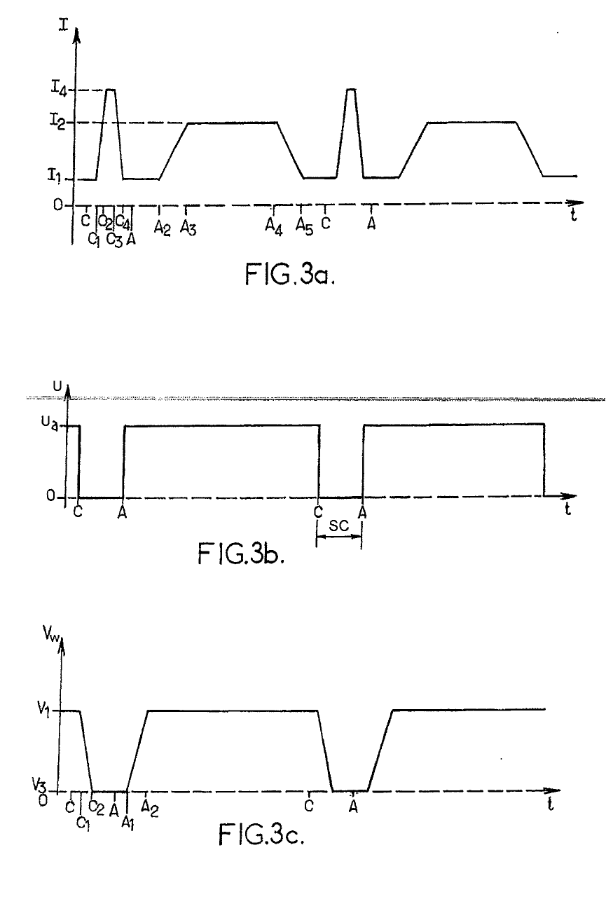

in the case of FIGS. 3a to 3c, while a welding process according to the present invention is being carried out.

More precisely, each series of FIGS. 1a to 1c, 2a to 2c and 3a to 3c shows the variation in the current (I), in the voltage (U) and in the wire speed (V_{w}) as a function of the time (t) plotted on the same scale on the x-axis for the CSC process, the STT process and the process according to the invention, respectively. However, it should be noted that the time (t) scales of each series of diagrams are not necessarily comparable to one another.

Moreover, it goes without saying that a short-circuit period (SC) followed by an arc period is repeated as many times as necessary for carrying out the desired welding, that is to say to produce the entire welded joint.

In all of FIGS. 1, 2 and 3, a transfer period which substantially elapses between one instant A and the next instant A and a short-circuit period (SC) between the instants C and A.

FIGS. 1a to 1c illustrate the succession of variations in the main parameters as a function of time t for a CSC process according to the prior art, in particular the variation in the current I flowing in the workpiece (FIG. 1a), the voltage u between the workpiece(s) to be welded and the consumable electrode (FIG. 1b) and the speed V_{w} of the consumable wire electrode (FIG. 1c).

The term “transfer cycle” refers to a succession of steps between the deposition of two successive metal droplets. As mentioned above, and in general, the deposition of a metal droplet takes place at the end of a short-circuit.

In FIG. 1b, it may be seen that the voltage Uₐ (arc voltage) is approximately constant and non-zero between the instants A and C and approximately equal to zero between the instants C and A that correspond to the time period during which the short-circuit takes place.

As shown in FIG. 1a, the current 11 is low between the instants C and A and is kept low until A₁. It then increases, reaching a value I₂, resulting in the wire electrode melting, and then comes back down again before the next instant C.

Furthermore, as illustrated in FIG. 1c, the wire undergoes a forward-and-back reciprocating mechanical movement. Its speed varies from an approximately constant speed V₁, dropping to zero before reaching a negative speed V₂, enabling the droplet to be mechanically deposited into the weld pool. Then, after a rise from the hold value V₂ the speed again becomes positive, before reaching the speed V₁.

According to the CSC process, the absolute value of V₂ is of the same order of magnitude as that of V₁. The speed reduction is controlled by the start of the short-circuit phase, reaching negative speed V₂ before the end of the short-circuit phase.

To summarize, the CSC process makes it possible, by a reciprocating movement of the wire feed, to reduce the energy to strike the arc and thus eliminate metal spatter.

However, this process is limited, especially in terms of the amount deposited, that is to say the volume of metal of the wire electrode deposited, because of the requirement to remain in short-circuit transfer mode and because of the relatively low transfer frequency, as explained above.

FIGS. 2a to 2c illustrate, in the same way as in FIGS. 1a to 1c, the succession of variations of the main parameters as a function of time t for an STT process according to the prior art.

According to the STT welding process, the speed V₁ of the consumable wire electrode (see FIG. 2c) is constant and approximately equal to that in a standard GMAW process.

As shown in FIG. 2a, the particular feature of the STT process is essentially the presence of a current pulse I during the short-circuit period between the instants A and C, the current reaching a value of I₃ greater than the current I₂ in the arc period. To do this, a specific detection means sends a current pulse just before the arc is reignited, so as to initiate the necking of the liquid metal bridge formed between the consumable electrode and the weld pool, for the purpose of preventing the spatter caused by striking at the arc under a high current.

Furthermore, as can be seen in FIG. 2b, the voltage u varies in a similar way to that in the CSC process.

However, this STT process is complicated to implement and requires, as mentioned above, many parameters to be precisely regulated.

FIGS. 3a to 3c illustrate, in an identical way to the previous figures, the succession of variations in the main parameters as a function of time t for a process according to the present invention.

As in the case of the other processes, the arc welding process according to the invention comprises welding cycles following one after another over the course of time (t), each comprising an arc period or regime (voltage Uₐ between instants A and C) and a short-circuit period or regime (zero voltage between instants A and C) where the liquid metal establishes the short-circuit (SC) between the consumable electrode and one (or more) workpieces to be welded.

However, according to the process of the invention, an arc current I₂ is maintained for a period (from A₃ to A₄) of the arc regime at the same time as the wire is moved at an approximately constant speed V₁, towards the workpiece so as to obtain a molten metal droplet on the end of the consumable electrode.

Next, the current is reduced (from I₂), reaching (instant A₅) a minimum value I₁ at the start of the short-circuit period (instant C) for the purpose of preventing, at the start of the short-circuit (SC), the spattering that is usually caused by instabilities in molten metal transfer owing to too high a current.

Furthermore, as shown in FIG. 3c, the speed of the wire is reduced (from V₁), reaching a minimum value V₃, lower than V₁ during the short-circuit period (SC), so as to initiate or improve the necking of the liquid bridge or neck between the filler wire and the weld pool.

As shown in FIG. 3a, the current is then increased during the short-circuit period SC (between the instants C and A), reaching a maximum value I₄, equal to or greater than the arc current I₂, preferably I₄>I₂, thereby causing the necking of the liquid bridge or neck between the filler wire and the weld pool, which comes to completion owing to the surface tension of the weld pool.

Finally, the current is reduced (from I₄) during the short-circuit period, before reaching (at A) a minimum value I₁ below the arc current I₂, thus concluding a metal transfer cycle under a low current and consequently eliminating the instability in molten metal transfer when restriking the arc at the start of the next cycle.

Stated another way, the very brief current peak I₄ combined with a rapid current drop down to I₁ allows the arc to be restruck at low current, therefore eliminating any spattering characteristic of this phase.

Furthermore, by stopping the wire during the short-circuit phase (SC), visible in FIG. 3c, it is possible to reduce the current peak compared with a system in which the wire continues to be paid out during this phase, as is the case with, for example, the STT process.

Moreover, with the STT process, the conventional operation of the current peak may require the use of a means for specifically detecting the voltage so as to localize, during the short-circuit, the necking of the filler metal and then to be able to reduce the current before restriking the arc. This detection is made complicated owing to the fact that the wire continues to advance during the short-circuit phase.

However, this problem does not occur with the process of the invention since the wire is stopped (zero V_{w}) during the short-circuit phase, making it easier to detect the necking of the filler metal.

In addition, conventional use of the current peak, as in the STT process, suffers from limitations in terms of the maximum operating current because of the instabilities caused when a high pay-out speed (and therefore a high average current) is applied during the short-circuit phase.

Now, here again, these negative effects do not exist with the process of the invention because the wire is stopped during the short-circuit, thereby enabling the current limitations to be relaxed.

The current I₄ during the short-circuit period is shown in FIG. 3 to be above the current I₂ occurring during the arc period. However, trials have shown that these values may be substantially of the same order of magnitude and essentially depend on the energy needed to initiate the detachment of the molten metal droplet, which varies depending on the materials welded.

In other words, according to the process of the invention, it is unnecessary for the current I₄ to be increased very significantly above the current I₂, unlike in the STT process in which the current I₃ is in general very significantly greater than the current I₂ (see FIG. 2a). This is due to the inertia introduced by reducing the wire feed speed during the short-circuit.

It should be noted that, as can be seen in FIG. 3b, the voltage u in the process of the invention varies in a similar way to that in the CSC and STT processes.

Purely by way of example, a process according to the invention can be implemented under the following conditions:

I₁: 5 to 100 A;

I₂: 50 to 200 A;

I₄: 100 to 300 A;

A-C duration: 5 to 20 ms;

C-A duration: 2 to 7 ms;

SC duration: 7 to 27 ms;

Uₐ: 5 to 30 V;

the wire speed V₁ during the arc period is around 15 to 40 m/min; and

the minimum wire speed V₃ is of the order of ±1 m/min.

### EXAMPLE

The welding process according to the present invention was successfully implemented and allowed two metal sheets 0.6 mm in thickness to be butt-welded together with a welding speed of around 2.5 m/min.

The shielding gas used was an argon/CO₂ gas mixture sold under the name ATAL 5 by Air Liquide.

The welding conditions were:

I₁=40 A; I₂=130 A; I₄=250 A; V₁=10 m/min; V₃=0 m/min; Uₐ=20 V; and

material: P 265 GH, black steel, A42.

The weld bead obtained was of good quality, being very compact and free of porosity, with very little deformation of the sheet.

To obtain such results is particularly surprising when it is known that the CSC process is limited to the welding of sheets with a minimum thickness of around 0.8 to 1 mm and that the welding speeds achievable do not exceed 1 to 1.5 m/min.

It should also be noted that the device for implementing the present invention may be simplified compared to that of a device with a reciprocating wire movement since it is possible to dispense with means for imposing a negative speed on the consumable wire electrode.

The device is made up in particular of:

a welding generator for controlling and regulating electrical welding parameters and the feed motor and for recovering the welding gas and transmitting it at the desired time to the assembly;

a wire electrode pay-out system for feeding this wire from the spool or the drum in which it is stored to the welding torch;

a torch assembly for transmitting information from the feed motor to the welding generator, and vice versa, but also for transferring gas and electricity from the welding generator to the torch; and

a welding torch providing a gas shield necessary for execution of the weld and for transferring electricity to the consumable wire, while guiding it.

It will be understood that many additional changes in the details, materials, steps and arrangement of parts, which have been herein described in order to explain the nature of the invention, may be made by those skilled in the art within the principle and scope of the invention as expressed in the appended claims. In addition, the present invention is not limited to the embodiments exemplified but should instead be interpreted in a non-limiting manner and encompassing any equivalent embodiments.

What is claimed:

1. An arc welding process employing a consumable electrode, one end of which is progressively melted by an electric current supplied to the electrode, in which welding cycles (A-C-A) follow one after another over the course of time (t), each comprising an arc period (Uₐ; instants A-C) and a short-circuit period (C-A) in which the liquid metal establishes a short-circuit (SC) between the molten end of the electrode and at least one workpiece to be welded, each cycle comprising the steps of:
a) maintaining an arc current I₂ for a period (A₃ to A₄) of the arc period (A-C) at the same time as the consumable electrode is moved at a speed V₁ towards the workpiece to be welded;
b) reducing the current so as to reach a minimum current I₁ at the start (at C) of the short-circuit period, where I₁<I₂;
c) reducing the speed of the consumable wire electrode in order to reach a minimum speed V₃, where V₃<V₁, during at least part of the short-circuit period (C-A);
d) increasing the current over the short-circuit period (C-A) in order to reach a maximum value I₄, where I₄≧I₂; and
e) then, after step d), reducing the current over the short-circuit period (C-A) in order to reach a minimum value I₁, where I₁<I₂.

2. The process of claim 1, wherein the minimum speed V₃ is approximately zero.

3. The process of claim 1, wherein the minimum speed V₃ is maintained at the start of the arc period (at A).

4. The process of claim 1, wherein at step d), the increase in the current (from I₁ to I₄) over the short-circuit period takes place while the speed of the consumable wire electrode is being reduced (from V₁ to V₃) in step c).

5. The process of claim 1, wherein the increase in the current (from I₁ to I₄) over the short-circuit period and the reduction in the speed of the wire electrode down to the minimum speed V₃ causes at least one droplet of molten metal to be detached.

6. The process of claim 1, wherein the maximum current I₄ is maintained during a hold period (C₂ to C₃) while the speed of the consumable wire electrode is maintained at the minimum speed V₃.

7. The process of claim 1, wherein the voltage is measured so as to trigger the drop in current before the arc is re-established, while the speed of the consumable wire electrode is maintained at the minimum speed V₃.

8. The process of claim 1, wherein during welding, a gas shield is employed and one or more metal workpieces, made of a metal or a metal alloy chosen from coated or uncoated carbon steels, coated or uncoated stainless steels and coated or uncoated aluminium or titanium, are welded.

9. The process of claim 2, wherein the minimum speed V₃ is maintained at the start of the arc period (at A).

10. The process of claim 9, wherein at step d), the increase in the current (from I₁ to I₄) over the short-circuit period takes place while the speed of the consumable wire electrode is being reduced (from V₁ to V₃) in step c).

11. The process of claim 10, wherein the increase in the current (from I₁ to I₄) over the short-circuit period and the reduction in the speed of the wire electrode down to the minimum speed V₃ causes at least one droplet of molten metal to be detached.

12. The process of claim 11, wherein the maximum current I₄ is maintained during a hold period (C₂ to C₃) while the speed of the consumable wire electrode is maintained at the minimum speed V₃.

13. The process of claim 12, wherein the voltage is measured so as to trigger the drop in current before the arc is re-established, while the speed of the consumable wire electrode is maintained at the minimum speed V₃.

14. The process of claim 13, wherein during welding, a gas shield is employed and one or more metal workpieces, made of a metal or a metal alloy chosen from coated or uncoated carbon steels, coated or uncoated stainless steels and coated or uncoated aluminium or titanium, are welded.

15. A device for controlling the power supply to a short-circuit metal-transfer arc-welding generator employing a consumable electrode, said generator comprising means for supplying electric current and a control circuit that is capable of implementing an arc welding process employing a consumable electrode, one end of which is progressively melted by an electric current supplied to the electrode, in which welding cycles (A-C-A) follow one after another over the course of time (t), each comprising an arc period (Uₐ; instants A-C) and a short-circuit period (C-A) in which the liquid metal establishes a short-circuit (SC) between the molten end of the electrode and at least one workpiece to be welded, each cycle comprising the steps of:
a) maintaining an arc current I₂ for a period (A₃ to A₄) of the arc period (A-C) at the same time as the consumable electrode is moved at a speed V₁ towards the workpiece to be welded;
b) reducing the current so as to reach a minimum current I₁ at the start (at C) of the short-circuit period, where I₁<I₂;
c) reducing the speed of the consumable wire electrode in order to reach a minimum speed V₃, where V₃<V₁, during at least part of the short-circuit period (C-A);
d) increasing the current over the short-circuit period (C-A) in order to reach a maximum value I₄, where I₄≧I₂; and
e) then, after step d), reducing the current over the short-circuit period (C-A) in order to reach a minimum value I₁, where I₁<I₂.

16. A computer program product for a data processing means, the computer program product comprising a series of instructions which, when they are input into the data processing means, enable the data processing means to carry out one or more of the steps of an arc welding process employing a consumable electrode, one end of which is progressively melted by an electric current supplied to the electrode, in which welding cycles (A-C-A) follow one after another over the course of time (t), each comprising an arc period (Uₐ; instants A-C) and a short-circuit period (C-A) in which the liquid metal establishes a short-circuit (SC) between the molten end of the electrode and at least one workpiece to be welded, each cycle comprising the steps of:
a) maintaining an arc current I₂ for a period (A₃ to A₄) of the arc period (A-C) at the same time as the consumable electrode is moved at a speed V₁ towards the workpiece to be welded;
b) reducing the current so as to reach a minimum current 11 at the start (at C) of the short-circuit period, where I₁<I₂;
c) reducing the speed of the consumable wire electrode in order to reach a minimum speed V₃, where V₃<V₁, during at least part of the short-circuit period (C-A);
d) increasing the current over the short-circuit period (C-A) in order to reach a maximum value I₄, where I₄≧I₂; and
e) then, after step d), reducing the current over the short-circuit period (C-A) in order to reach a minimum value I₁, where I₁<I₂.

17. A computer-readable medium, comprising one or more sequences of instructions for the computer program product according to claim 16.

18. A MIG/MAG welding current generator comprising means for supplying electric current and a device for controlling said power supply means according to claim 15 and/or employing a computer program product according to claim 16 and/or a medium according to claim 17.
